(19) United States
(12) Patent Application Publication
(10) Pub. No.: US 2025/0208358 A1
(43) Pub. Date: Jun. 26, 2025

(54) OPTICAL FIBER ACCESSORY

(71) Applicant: Gloriole Electroptic Technology Corp., Kaohsiung City (TW)

(72) Inventors: Hsien-Hsin HSU, Kaohsiung City (TW); Yu-Cheng CHEN, Kaohsiung City (TW); Jim LIN, Kaohsiung City (TW)

(21) Appl. No.: 18/639,424

(22) Filed: Apr. 18, 2024

(30) Foreign Application Priority Data
Dec. 22, 2023 (TW) 112214057

(51) Int. Cl. G02B 6/38; H04B 10/079

(52) U.S. Cl. CPC G02B 6/385; G02B 6/3827; G02B 6/387; G02B 6/3879; G02B 6/3881; H04B 10/0793

(57) ABSTRACT

An optical fiber accessory includes a front housing, a rear housing sleeve, and a loopback module. The front housing defines two insertion slots extending in a front-rear direction and spaced apart from each other in a first direction perpendicular to the front-rear direction, and two core slots being respectively in spatial communication with the insertion slots. The rear housing sleeve is sleeved on a rear end of the front housing and defines a receiving space in spatial communication with the core slots. The loopback module is disposed in the rear housing sleeve, and includes two ferrules fixed onto the rear housing sleeve, and an optical fiber loop having two ends respectively connected to the ferrules and disposed in the receiving space. The ferrules project toward the front housing in the front-rear direction and extend respectively into the core slots.

### CROSS-REFERENCE TO RELATED APPLICATION

This application claims priority to Taiwanese Utility Model Patent Application No. 112214057, filed on Dec. 22, 2023, the entire disclosure of which is incorporated by reference herein.

### FIELD

The disclosure relates to an accessory, and more particularly to an optical fiber accessory that may be used for optical fiber inspection.

### BACKGROUND

Referring to FIG. 1, when a conventional optical fiber apparatus 11 is to communicate with an optical fiber device 12, an optical fiber network needs to be established first for transmitting signals therebetween. After the optical fiber network is established, inspection (e.g., whether the optical fiber network is properly laid out, whether defects exist, and whether communication is good) on the optical fiber network is needed. Traditionally, when performing an insertion loss test, an optical return loss test, and other tests on the optical fiber network, a transmitting end (TX) of the optical fiber apparatus 11 needs to be connected to a receiving end (RX) of the optical fiber device 12 through an optical fiber jumper (not shown). Meanwhile, a receiving end (RX) of the optical fiber apparatus 11 is connected to a transmitting end (TX) of the optical fiber device 12 through another optical fiber jumper (not shown). Two testing instruments (not shown) are connected respectively to the optical fiber apparatus 11 and the optical fiber device 12. Furthermore, two testing individuals need to be dispatched to the optical fiber apparatus 11 and the optical fiber device 12 respectively for performing the aforementioned tests. Such testing method involves more equipment and manpower, and requires operations such as wiring, connecting the optical fiber jumpers, etc., so this method is less efficient and labor intensive. In addition, testing may not be carried out when the optical fiber apparatus 11 is connected to the optical fiber jumpers but not yet to the optical fiber device 12. The tests are not able to be performed until the optical fiber device 12 is installed, so problems cannot be discovered early if any, thereby resulting in waste of time and manpower. Furthermore, the aforementioned inspection is performed on an entirety of the optical fiber network in which the optical fiber apparatus 11 and the optical fiber device 12 are connected, and not on the optical fiber jumpers.

### SUMMARY

Therefore, an object of the disclosure is to provide an optical fiber accessory that can alleviate at least one of the drawbacks of the prior art.

According to the disclosure, the optical fiber accessory includes a front housing, a rear housing sleeve, and a loopback module.

The front housing defines two insertion slots extending in a front-rear direction and spaced apart in a first direction perpendicular to the front-rear direction, and two core slots extending in the front-rear direction and respectively communicating with the insertion slots.

The rear housing sleeve is sleeved on a rear end of the front housing and defines a receiving space communicating with the core slots.

The loopback module is disposed in the rear housing sleeve, and includes two ferrules fixed onto the rear housing sleeve and spaced apart from each other in the first direction, and an optical fiber loop having two ends respectively connected to the ferrules and disposed in the receiving space. The ferrules project toward the front housing in the front-rear direction and extend respectively into the core slots.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a conventional inspection method of an optical fiber device and an optical fiber apparatus.

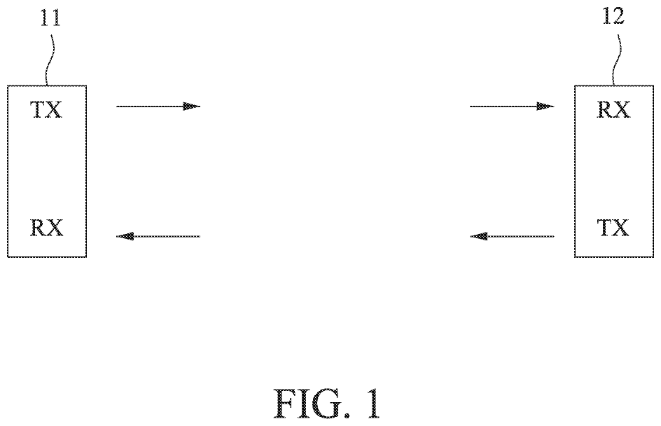

FIG. 2 is a perspective view illustrating an embodiment of an optical fiber accessory according to the present disclosure.

FIG. 3 is an exploded perspective view illustrating components of an assembly of FIG. 2.

FIG. 4 is a top sectional view of FIG. 2.

FIG. 5 is a side sectional view of FIG. 2.

FIG. 6 is a perspective view illustrating an actual application of the embodiment.

FIG. 7 is a top sectional view of FIG. 6.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

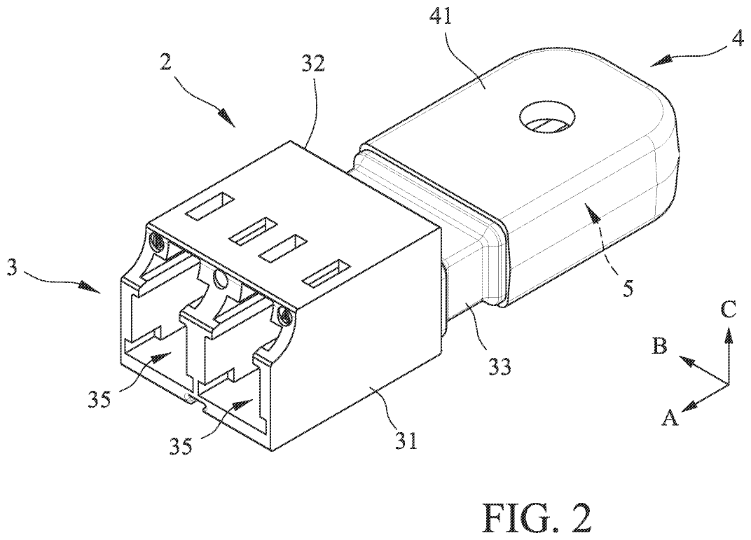

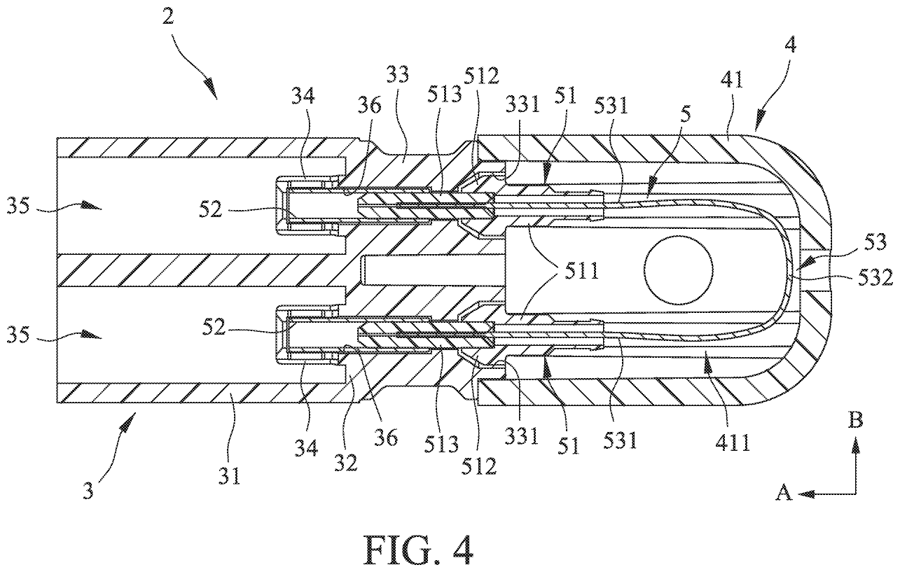

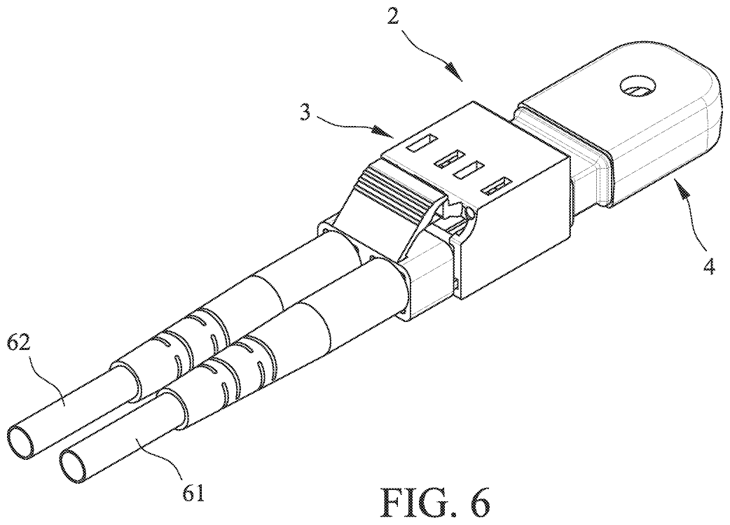

Referring to FIGS. 2, 3, and 4, an embodiment of an optical fiber accessory 2 of the present disclosure is adapted for connecting two optical fiber jumpers 61, 62 (FIG. 6). The optical fiber jumpers 61, 62 (FIG. 6) respectively connected to a transmitting end and a receiving end of an optical fiber apparatus (not shown) in an optical fiber network. The optical fiber accessory 2 includes a front housing 3, a rear housing sleeve 4 sleeved on a rear end of the front housing 3, and a loopback module 5 disposed in the front housing 3 and the rear housing sleeve 4.

The front housing 3 includes a surrounding wall 31, an end wall 32 connected to a rear end of the surrounding wall 31, an extension housing 33 extending from the end wall 32 toward the rear housing sleeve 4 in a front-rear direction (A), and two connecting tube walls 34 projecting from the end wall 32 and away from the extension housing 33 in the front-rear direction (A), and spaced apart from each other in a first direction (B) perpendicular to the front-rear direction (A). The surrounding wall 31 and the end wall 32 cooperatively define two insertion slots 35 extending in the front-rear direction (A) and spaced apart from each other in the first direction (B). The connecting tube walls 34 are located respectively in the insertion slots 35. The end wall 32, the extension housing 33, and the connecting tube walls 34 cooperatively define two core slots 36 extending in the front-rear direction (A) and being respectively in spatial communication with the insertion slots 35. Each of the core slots 36 extends from the connecting tube wall 34 in a corresponding one of the insertion slots 35 into the extension housing 33 in the front-rear direction (A). The extension housing 33 defines two positioning grooves 331 being respectively in spatial communication with the core slots 36 and facing the rear housing sleeve 4. Each of the positioning grooves 331 is a polygonal hole.

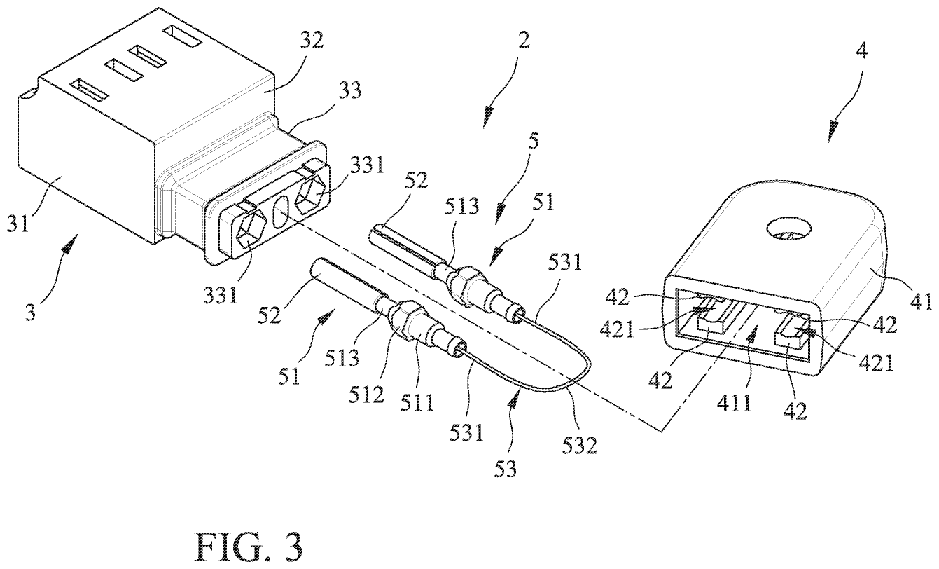

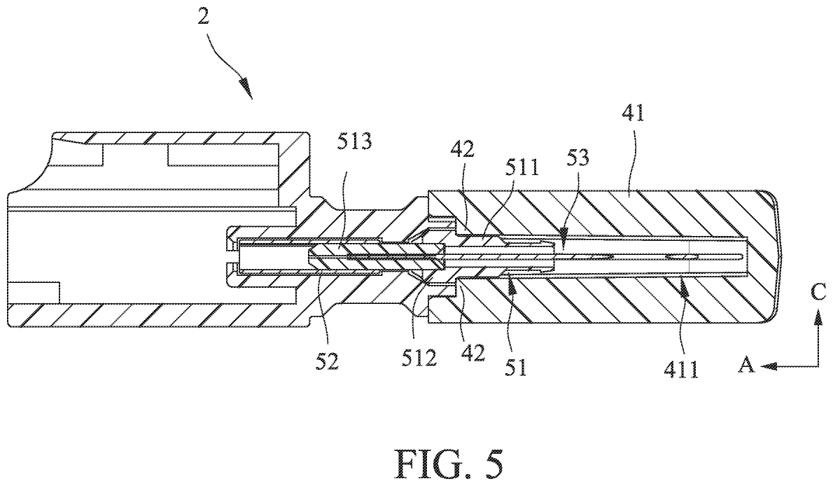

Referring to FIGS. 3, 4, and 5, the rear housing sleeve 4 includes an outer housing wall 41 defining a receiving space 411 in spatial communication with the core slots 36, and four clamping blocks 42 disposed in pairs in the receiving space 411 and protruding from an inner surface of the outer housing wall 41. The outer housing wall 41 is connected to the extension housing 33. In specific words, the outer housing wall 41 is sleeved on a rear end of the extension housing 33. The pairs of the clamping blocks 42 are spaced apart from each other in the first direction (B). The clamping blocks 42 of a same pair are spaced apart from each other in a second direction (C) perpendicular to the first direction (B) and the front-rear direction (A). Each of the clamping blocks 42 is formed with a limiting groove 421 that is recessed inwardly in the second direction (C), and each of the limiting grooves 421 extends in the front-rear direction (A).

The loopback module 5 includes two ferrules 51 each being clamped by the clamping blocks 42 of the same pair and respectively extending through the positioning grooves 331, two tubular sleeves 52 respectively connected to the ferrules 51 (for permitting the ferrules 51 to be inserted therein, respectively) and respectively inserted into the core slots 36 of the front housing 3, and an optical fiber loop 53 having two ends respectively connected to the ferrules 51 and disposed in the receiving space 411. The ferrules 51 are fixed onto the rear housing sleeve 4 and spaced apart from each other in the first direction (B). The ferrules 51 project toward the front housing 3 in the front-rear direction (A) and extend respectively into the core slots 36. Each of the ferrules 51 includes a core tubular portion 511 clamped by a corresponding one pair of the clamping blocks 42 and engaging two corresponding ones of the limiting grooves 421, a positioning portion in 512 disposed on a front end of the core tubular portion 511 and engaging a corresponding one of the positioning grooves 331, and a core head portion 513 extending forwardly from the positioning portion 512 in the front-rear direction (A) and having a distal end inserted into a corresponding one of the tubular sleeves 52. A cross section of each of the positioning portions 512 matches that of the corresponding one of the positioning grooves 331, which is polygonal, such that when the positioning portions 512 engage respectively with the positioning grooves 331, a rotational degree of freedom of the ferrules 51 may be limited, such that the ferrules 51 do not rotate arbitrarily. The core head portion 513 together with a corresponding one of the tubular sleeves 52 extends into the corresponding one of the core slots 36. The optical fiber loop 53 includes two elongated straight sections 531 connected respectively to the core tubular portions 511 and each extending in the front-rear direction (A), and a bending section 532 extending curvedly in the first direction (B) and interconnecting the elongated straight sections 531.

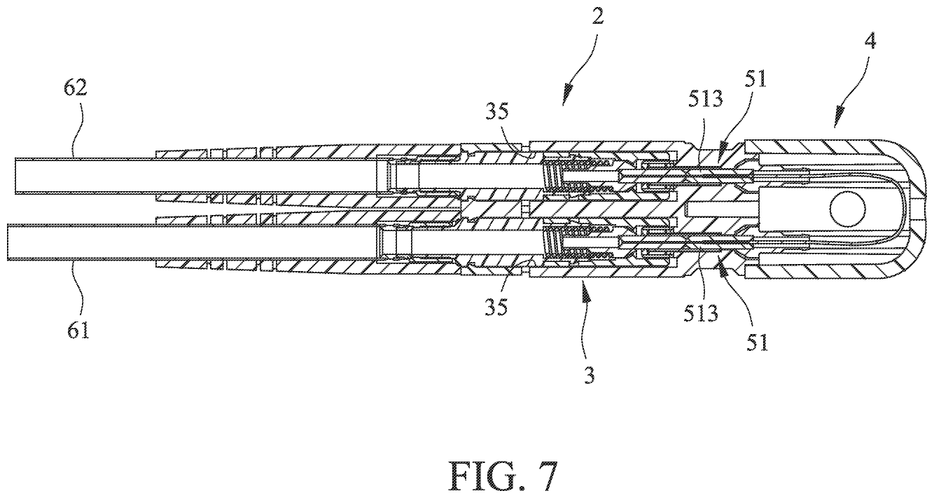

Referring to FIGS. 3, 6, and 7, in practice, the optical fiber jumpers 61, 62 may be directly inserted into the insertion slots 35, respectively, and the optical fiber jumpers 61, 62 abut against the core head portions 513 of the ferrules 51, respectively. Accordingly, signals transmitted by the optical fiber apparatus may be transmitted to the optical fiber loop 53 via the transmitting end and the optical fiber jumper 61. The signals are then sent back to the optical fiber apparatus through the optical fiber loop 53 and the optical fiber jumper 62, thereby simulating data transmission, so the inspection personnel may perform an insertion loss test, an optical return loss test, or other tests. An additional connection with an optical fiber device (not shown) is not needed in the tests, so interference caused by the optical fiber device may be reduced. As a result, issues with the optical fiber jumpers 61, 62 may be identified more precisely, and transmission capabilities, receiving sensitivity, and other performance metrics of the optical fiber apparatus are verified. In this way, only one testing individual is required to complete the tests on the optical fiber apparatus, and testing may be conducted before the optical fiber apparatus is connected to the optical fiber device, thereby improving operational efficiency and reducing manpower. Furthermore, in this embodiment, the optical fiber apparatus may be formed with a closed loop for better protection.

In summary, the optical fiber accessory 2 of the present disclosure may be connected to the optical fiber jumpers 61, 62 so that the optical fiber apparatus is formed with a loop. By virtue of the optical fiber loop 53, signal loopback (i.e., routing of the signals back to their source) is implemented to simulate processes of signal transmission and reception, thereby enabling quick optical fiber tests. In addition to inspect the physical qualities such as insertion losses, by virtue of comparing signals transmitted between the optical fiber jumpers 61, 62, the signal quality of the optical fiber network may be further determined, thereby determining whether the signal quality is acceptable within a range. Therefore, compared to the conventional testing method, the present disclosure may be used to perform different tests and be utilized as a manual protective measure. The object of the present disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical fiber accessory, comprising:
a front housing defining two insertion slots extending in a front-rear direction and spaced apart from each other in a first direction perpendicular to the front-rear direction, and two core slots extending in the front-rear direction and being respectively in spatial communication with said insertion slots;
a rear housing sleeve sleeved on a rear end of said front housing and defining a receiving space in spatial communication with said core slots; and
a loopback module disposed in said rear housing sleeve, and including two ferrules fixed onto said rear housing sleeve and spaced apart from each other in the first direction, and an optical fiber loop having two ends respectively connected to said ferrules and disposed in said receiving space, said ferrules projecting toward said front housing in the front-rear direction and extending respectively into said core slots.

2. The optical fiber accessory as claimed in claim 1, wherein said optical fiber loop has two elongated straight sections that are respectively connected to said ferrules and that extend in the front-rear direction, and a bending section that extends curvedly in the first direction and that interconnects said elongated straight sections.

3. The optical fiber accessory as claimed in claim 1, wherein said rear housing sleeve includes an outer housing wall defining said receiving space, and four clamping blocks disposed in pairs in said receiving space and protruding from an inner surface of said outer housing wall, said pairs of said clamping blocks being spaced apart from each other in the first direction, and respectively clamping said ferrules of said loopback module.

4. The optical fiber accessory as claimed in claim 3, wherein said clamping blocks of a same pair are spaced apart in a second direction that is perpendicular to the first direction and the front-rear direction, so as to clamp a corresponding one of said ferrules of said loopback module.

5. The optical fiber accessory as claimed in claim 4, wherein each of said clamping blocks of said rear housing sleeve is formed with a limiting groove that is recessed inwardly in the second direction, each of said limiting grooves extending in the front-rear direction, said limiting grooves of said clamping blocks of said same pair are configured for engagement with said corresponding one of said ferrules.

6. The optical fiber accessory as claimed in claim 5, wherein said front housing includes a surrounding wall, an end wall connected to a rear end of said surrounding wall and cooperating with said surrounding wall to define said insertion slots, and an extension housing extending from said end wall in the front-rear direction toward said rear housing sleeve and connected to said outer housing wall of said rear housing sleeve, said extension housing defining two positioning grooves being respectively in spatial communication with said core slots and facing said rear housing sleeve, each of said positioning grooves having a polygonal shape, said positioning grooves respectively permitting said ferrules to be engaged therein.

7. The optical fiber accessory as claimed in claim 6, wherein each of said ferrules of said loopback module includes a core tubular portion clamped by a corresponding one pair of said clamping blocks, a positioning portion disposed on a front end of said core tubular portion and engaging a corresponding one of said positioning grooves, and a core head portion extending forwardly from said positioning portion in the front-rear direction and into a corresponding one of said core slots.

8. The optical fiber accessory as claimed in claim 6, wherein said front housing further includes two connecting tube walls projecting from said end wall and respectively located in said insertion slots, each of said core slots extending from a corresponding one of said connecting tube walls into said extension housing in the front-rear direction, and being connected to said corresponding one of said positioning grooves.

9. The optical fiber accessory as claimed in claim 1, wherein said loopback module further includes two tubular sleeves respectively inserted into said core slots of said front housing and permitting said ferrules to be inserted therein, respectively.
